(19) United States
(12) Patent Application Publication
(10) Pub. No.: US 2012/0125723 A1
(43) Pub. Date: May 24, 2012

(54) DISK BRAKE ASSEMBLY

(75) Inventors: Albert C. Wong, Saginaw, MI (US); Tom Cheuk-In Wong, Saginaw, MI (US)

(73) Assignee: GM GLOBAL TECHNOLOGY OPERATIONS, INC., Detroit, MI (US)

(21) Appl. No.: 12/952,795

(22) Filed: Nov. 23, 2010

(51) Int. Cl. F16D 55/226; F16D 65/20

(52) U.S. Cl. 188/72.3

(57) ABSTRACT

A disk brake assembly having a rotor and a caliper is provided. The caliper has first and second body portions and an intermediate portion coupled between the body portions. The first body portion has a first brake pad coupled thereto. The second body portion has a bore extending therein that defines an inner surface. The assembly further includes a piston disposed within the bore. The piston has an end portion and a tubular body coupled to the end portion. The end portion has a second brake pad coupled thereto. The assembly further includes a positioning sleeve member disposed on a portion of the inner surface within a portion of the groove. The assembly further includes a spring disposed in the groove that moves the piston and the second brake pad away from the rotor in response to a decreased fluid pressure in the piston.

### FIELD OF THE INVENTION

The present application is directed to a disk brake assembly.

### BACKGROUND

Brake assemblies have been developed. However, brake pads in a brake assembly often undesirably contact a rotor after a piston holding one of the brake pads has been depressurized.

Accordingly, it is desirable to provide an improved disk brake assembly.

### SUMMARY OF THE INVENTION

A disk brake assembly in accordance with an exemplary embodiment is provided. The disk brake assembly includes a rotor and a caliper disposed proximate to the rotor. The caliper has first and second body portions and an intermediate portion. The intermediate portion is coupled between the first and second body portions. The first body portion has a first brake pad coupled thereto. The second body portion has a bore extending therein that defines an inner surface. The disk brake assembly further includes a piston disposed within the bore of the second body portion. The piston has an end portion and a tubular body coupled to the end portion. The tubular body has a groove extending circumferentially around the tubular body. The end portion has a second brake pad coupled thereto. The disk brake assembly further includes a positioning sleeve member disposed on a portion of the inner surface within a portion of the groove of the tubular body. The positioning sleeve member is frictionally engaged with the portion of the inner surface. The disk brake assembly further includes a spring disposed in the groove of the tubular body between the positioning sleeve member and an inner surface of the piston defined by the groove. The piston is configured to move the second brake pad in a first direction toward the rotor and to compress the spring against the positioning sleeve member in response to an increased fluid pressure therein. The spring is configured to move the piston and the second brake pad in a second direction away from the rotor in response to a decreased fluid pressure in the piston.

The above features and advantages and other features and advantages of the present invention are readily apparent from the following detailed description of the invention when taken in connection with the accompanying drawings.

### BRIEF DESCRIPTION OF THE DRAWINGS

Other objects, features, advantages and details appear, by way of example only, in the following detailed description of embodiments, the detailed description referring to the drawings in which:

FIG. 1 is a schematic of a disk brake assembly in accordance with an exemplary embodiment;

FIG. 2 is a cross-sectional view of a portion of the disk brake assembly of FIG. 1 in which a piston has a first operational position;

FIG. 3 is a cross-sectional view of a portion of the disk brake assembly of FIG. 1 in which the piston has a second operational position;

FIG. 4. is a front view of a positioning sleeve member utilized in the disk brake assembly of FIG. 1;

FIG. 5 is a side view of the positioning sleeve member of FIG. 4;

FIG. 6 is a front view of a spring utilized in the disk brake assembly of FIG. 1;

FIG. 7 is a side view of the spring of FIG. 6;

FIG. 8 is a cross-sectional view of a portion of another disk brake assembly in which a piston has a first operational position;

FIG. 9 is a cross-sectional view of a portion of the disk brake assembly of FIG. 8 in which the piston has a second operational position;

FIG. 10 is a front view of a spring utilized in the disk brake assembly of FIG. 8; and

FIG. 11 is a side view of the spring of FIG. 10.

### DESCRIPTION OF THE EMBODIMENTS

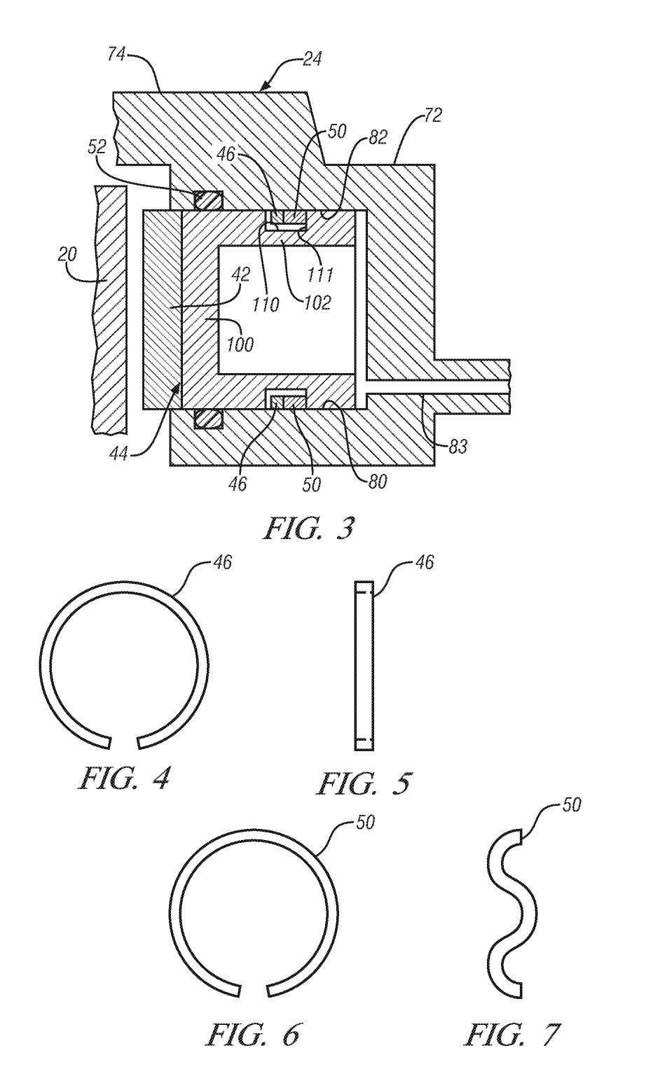

Referring to FIGS. 1-3, a vehicle 10 having a disk brake assembly 12 in accordance with an exemplary embodiment is provided. The disk brake assembly 12 includes a rotor 20, a hub 22, a caliper 24, brake pads 40, 42, a piston 44, a positioning sleeve member 46, a spring 50, and a seal 52. An advantage of the disk brake assembly 12 is that the assembly can actively move a brake pad away from a rotor to reduce frictional engagement between the brake pad and the rotor.

The caliper 24 holds the brake pads 40, 42 thereon and is disposed adjacent to the rotor 20. The caliper 24 includes body portions 70, 72 and an intermediate portion 74 coupled between the body portions 70, 72. The body portion 70 has the brake pad 40 disposed thereon, and the body portion 72 has the brake pad 42 disposed thereon. The body portion 72 includes a bore 80 that extends therein for receiving the piston 44 therein. The body portion 72 further includes an inner surface 82 defined by the bore 80. Also, the body portion 72 includes an aperture 83 therein that fluidly communicates with the bore 80. In one exemplary embodiment, the caliper 24 is constructed of steel.

The piston 44 is disposed within the bore 80 of the body portion 72. The piston 44 includes an end portion 100, and a tubular body 102 coupled to the end portion 100. The end portion 100 and the tubular body 102 define an interior region 104 for receiving fluid therein. The interior region 104 is configured to receive fluid from the aperture 83 therein. The tubular body has a groove 110 extending circumferentially around the tubular body 102. Further, the end portion 100 has the brake pad 42 coupled thereto. In one exemplary embodiment, the piston 44 is constructed of steel.

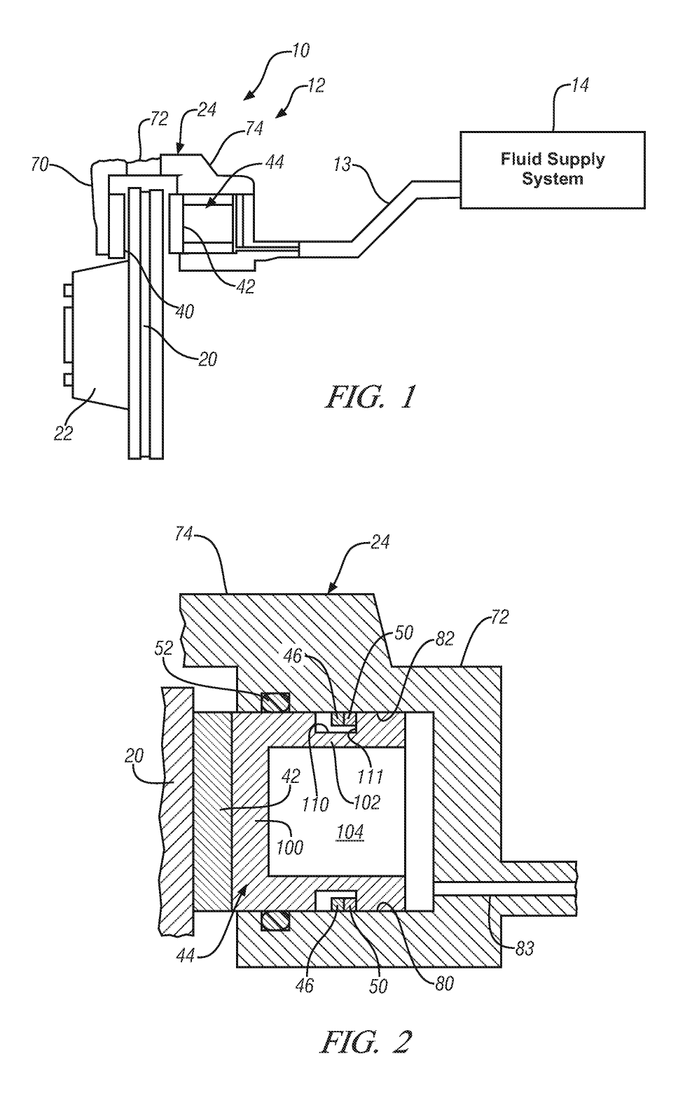

Referring to FIGS. 2-5, the positioning sleeve member 46 is disposed on a portion of an inner surface 82 of the body portion 72 within a portion of the groove 110 of the tubular body 102. The positioning sleeve member 46 is frictionally engaged with the portion of the inner surface 82. In one exemplary embodiment, the positioning sleeve member 46 is a split ring constructed of either steel or a titanium alloy. When the brake pads 40, 42 wears down and a thickness of each of the brake pads 40, 42 is decreased, the positioning sleeve member 46 can be automatically moved longitudinally (in a leftward direction in FIG. 2) by the piston 44 to compensate for the change in thickness of each of the brake pads 40, 42.

The spring 50 is disposed in the groove 110 of the tubular body 102 between the positioning sleeve member 46 and the inner surface 111 of the piston 44 defined by the groove 110. In one exemplary embodiment, the spring 50 is a wave spring having a gap therein and is constructed of either steel or a titanium alloy. The wave spring is a thin spring-washer in which waves have been pressed.

During operation, the piston 44 is configured to move the brake pad 42 in a first direction towards the rotor 20 to compress the spring 50 against the positioning sleeve member 46 in response to an increased fluid pressure within the interior region 104 of the piston 44. Further, the spring 50 is configured to move the piston 44 and the brake pad 42 in a second direction away from the rotor 20 in response to a decreased fluid pressure in the interior region 104 of the piston 44.

Referring to FIG. 1, the disk brake assembly 12 further includes the conduit 13 and the fluid supply system 14. The fluid supply system 14 is configured to supply fluid through the conduit 13 and the aperture 83 into the interior region 104 of the piston 44. The fluid supply system 14 is operably coupled to a brake pedal (not shown) or a switch (not shown) of the vehicle 10. The fluid supply system 14 can supply fluid with an increased pressure level to the piston 44 when the brake pedal is depressed by an operator or the switch has a closed operational position. Alternately, the fluid supply system 14 can decrease a pressure level of the fluid applied to the piston 44 when the brake pedal is released by the operator or the switch has an open operational position.

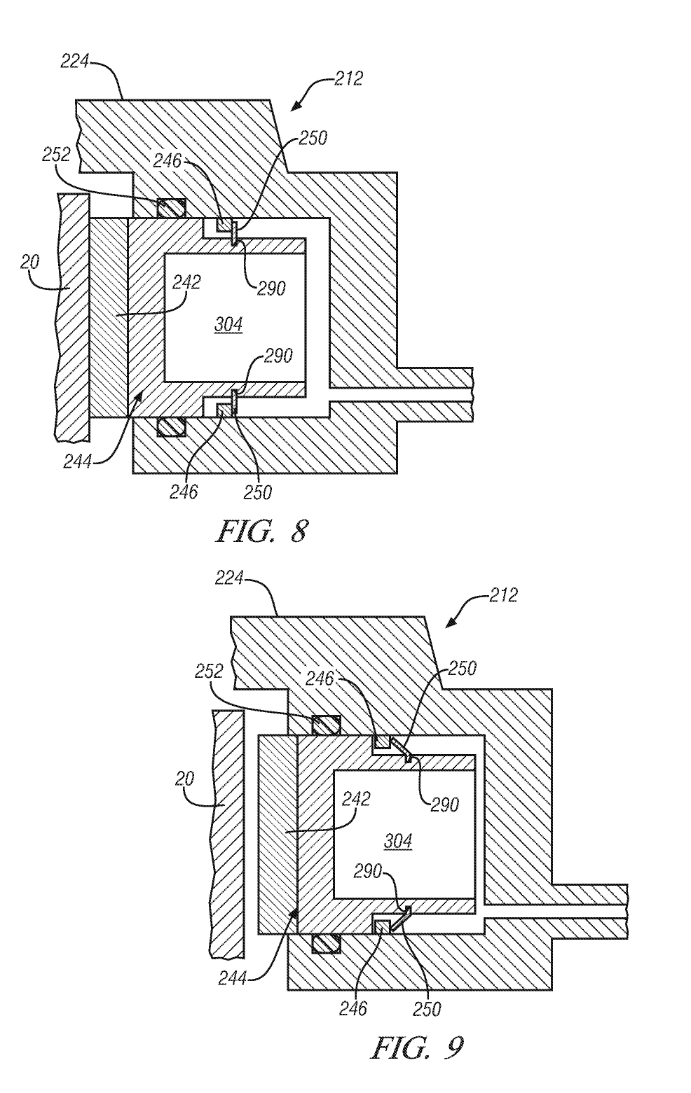

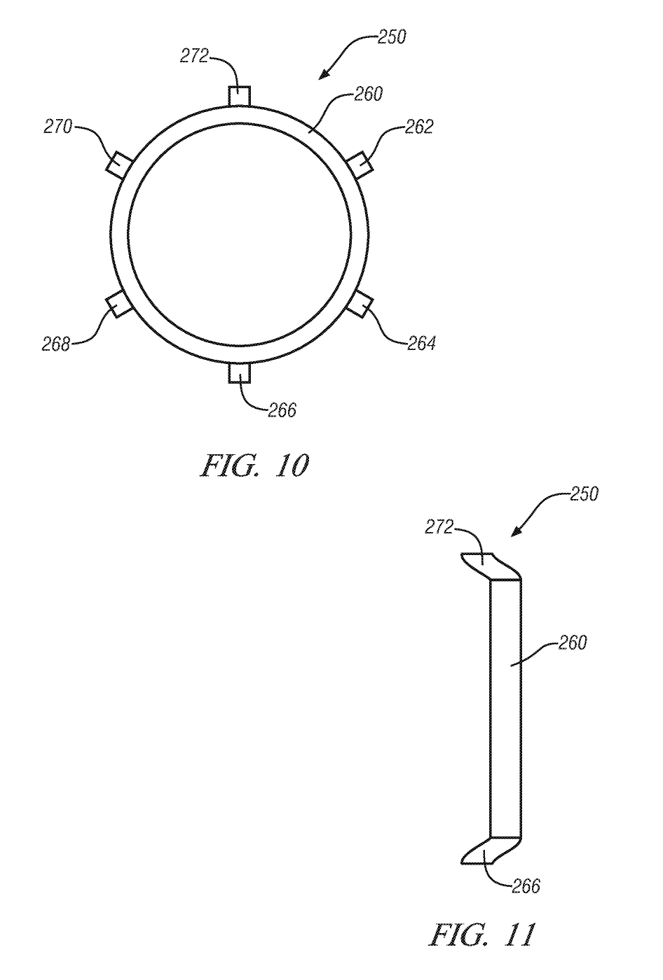

Referring to FIGS. 8-11, a portion of another disk brake assembly 212 in accordance with another exemplary embodiment is illustrated. The disk brake assembly 212 includes a caliper 224, a brake pad 242, a piston 244, a positioning sleeve member 246, a spring 250, and a seal 252. The caliper 244, the brake pad 242, the positioning sleeve member 246, and the seal 252 have a substantially similar structure as the caliper 24, the brake pad 42, the piston 44, the positioning sleeve member 46, and the seal 52, respectively. The piston 244 has a substantially similar structure as the piston 44 except that the piston 244 has a groove 290 disposed therein for receiving a portion of the spring 250 therein.

The spring 250 has a ring portion 260 and finger portions 262, 264, 266, 268, 270, 272 extending radially outwardly from the split ring portion 260. In the illustrated exemplary embodiment, each finger portion is disposed at an equidistant angle from adjacent finger portion. Of course, in an alternative embodiment, the finger portions are not disposed at equidistant angles from adjacent finger portions. The ring portion 260 is disposed within the groove 290 of the piston 244 and is fixedly held within the groove 290. The finger portions 262-272 contact the positioning sleeve member 246 as shown.

During operation, the piston 244 is configured to move the brake pad 242 in a first direction towards the rotor 20 to compress the finger portions 262-272 of the spring 250 against the positioning sleeve member 246 in response to an increased fluid pressure within an interior region 304 of the piston 244. Further, the spring 250 is configured to move the piston 244 and the brake pad 242 in a second direction away from the rotor 20 in response to a decreased fluid pressure in the interior region 304 of the piston 244.

The disk brake assemblies provide a substantial advantage over other disk brake assemblies. In particular, the disk brake assemblies bias a brake pad away from a rotor to reduce frictional engagement between the brake pad and the rotor when no braking force between the brake pad the rotor is desired.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed as the best mode contemplated for carrying out this invention, but that the invention will include all embodiments falling within the scope of the present application.

What is claimed is:

1. A disk brake assembly, comprising:
a rotor;
a caliper disposed proximate to the rotor, the caliper having first and second body portions and an intermediate portion, the intermediate portion being coupled between the first and second body portions, the first body portion having a first brake pad coupled thereto, the second body portion having a bore extending therein that defines an inner surface;
a piston being disposed within the bore of the second body portion, the piston having an end portion and a tubular body coupled to the end portion, the tubular body having a groove extending circumferentially around the tubular body, the end portion having a second brake pad coupled thereto;
a positioning sleeve member disposed on a portion of the inner surface within a portion of the groove of the tubular body, the positioning sleeve member being frictionally engaged with the portion of the inner surface;
a spring disposed in the groove of the tubular body between the positioning sleeve member and an inner surface of the piston defined by the groove; and
the piston configured to move the second brake pad in a first direction toward the rotor and to compress the spring against the positioning sleeve member in response to an increased fluid pressure therein, the spring configured to move the piston and the second brake pad in a second direction away from the rotor in response to a decreased fluid pressure in the piston.

2. The disk brake assembly of claim 1, wherein the positioning sleeve member is a split ring.

3. The disk brake assembly of claim 2, wherein the split ring is constructed of at least one or steel and a titanium alloy.

4. The disk brake assembly of claim 2, wherein the spring is a wave spring having a gap therein.

5. The disk brake assembly of claim 4, wherein the wave spring is a thin spring-washer into which waves have been pressed.

6. The disk brake assembly of claim 1, wherein the spring has a ring portion and a plurality of finger spring portions extending radially outwardly from the ring portion, the ring portion being disposed within another groove of the piston, the plurality of finger spring portions contacting the positioning sleeve member.
